(19) United States
(12) Patent Application Publication
(10) Pub. No.: US 2023/0348792 A1
(43) Pub. Date: Nov. 2, 2023

(54) MECHANICAL ACTIVATION OF BIOMASS FOR HYDROTHERMAL LIQUEFACTION

(71) Applicant: Worcester Polytechnic Institute, Worcester, MA (US)

(72) Inventors: Michael Timko, Arlington, MA (US); Heather LeClerc, Stafford Springs, CT (US); Geoffrey A. Tompsett, Shrewsbury, MA (US); Alex R. Maag, Whitinsville, MA (US); Andrew R. Teixeira, Boylston, MA (US)

(21) Appl. No.: 18/140,275

(22) Filed: Apr. 27, 2023

Related U.S. Application Data
(60) Provisional application No. 63/336,930, filed on Apr. 29, 2022.

(51) Int. Cl. C10G 3/00

(52) U.S. Cl. CPC C10G 3/50; C10G 2300/1003; C10G 2300/1014; C10G 2300/1018; C10G 2400/06; C10G 2300/4006

(57) ABSTRACT

Methods for obtaining a biocrude intermediate by hydrothermal liquefaction of plant wastes are provided. Using a waste feed having a high cellulose content, the method involves grinding the waste feed to obtain a pulverized waste feed, and subjecting the pulverized waste feed to hydrothermal liquefaction at a temperature at or greater than at about 250° C. At this temperature or greater a catalyst is not necessary to obtain the biocrude. A lower temperature can be used, such as greater than about 150° C. in presence of a catalyst. The step of grinding the plant material, for example ball grinding, reduces particle size and crystallinity, and combined with the high temperature treatment improves the yield of biocrude. Biocrude can be upgraded to biofuel by high temperature hydrodeoxygenating in the presence of hydrogen. Plant wastes that would otherwise contribute green house gases are instead converted to fuels.

### RELATED APPLICATION

This application claims the benefit of U.S. provisional application Ser. No. 63/336,930 filed Apr. 29, 2022, entitled “Mechanical activation of biomass for hydrothermal liquefaction”, inventors Michael Timko, Heather LeClerc, Andrew Teixeira, Geoffrey Tompsett, and Alex Maag, and which is hereby incorporated herein in its entirety.

### GOVERNMENT SUPPORT

This invention was developed, in part, with U.S. Government support under contract No. DE-EE0008513, awarded by the Department of Energy. The Government has certain rights in the invention.

### BACKGROUND

Production of biofuels and bioenergy has the potential to reduce greenhouse gas emissions, improve energy security, and reduce energy price volatility. Hydrothermal liquefaction is a method for converting organic wet waste into biofuels and bioenergy. The biggest obstruction in hydrothermal liquefaction is producing a biocrude intermediate that can be upgraded to a finished fuel. Wastes such as yard waste or green waste are abundant and inexpensive. The United States produces approximately 50 million tons of these types of wastes per year. See, National Overview: Facts and Figures on Materials, Wastes and Recycling.” EPA, Environmental Protection Agency, 29 Jun. 2022. Further, these wastes do not have a use because these wastes do not provide sufficient biocrude yield to be economically viable. If disposed of in landfills, these wastes contribute to carbon dioxide and methane pollution.

Therefore, there is an urgent need for methods to produce sufficient quantity of a biocrude intermediate using plant-based wastes including yard waste or green waste such that the method is economically viable.

### SUMMARY

An aspect of the invention herein provides a method for obtaining a biocrude intermediate by hydrothermal liquefaction of a cellulosic waste product, the method comprising:

obtaining a waste feed comprising high cellulose content;

grinding the waste feed to obtain a pulverized waste feed; and

subjecting the pulverized waste feed to hydrothermal liquefaction at a temperature greater than 250° C., thereby obtaining the biocrude intermediate. The methods confers a great double benefits to the ecology of the planet, as the waste feeds otherwise pollute the environment with green house gases carbon dioxide and even worse, methane gas as the feeds decay and occupy landfill, and further these methods provide biofuels. These methods are used efficaciously without an added chemical catalyst and without added enzymes. Embodiments of the method using temperatures lower than 250° C. are also suitable in the presence of a catalyst, for example a common zeolite, for example, ZSM-5, HY, ZSM-11, ZSM-23 and β are used at a lower temperature to obtain equivalent results.

Thus for various embodiments of the methods the waste feed includes at least one of: green waste, yard waste, zoo waste feed, zoo herbivore animal fecal matter, florist industry waste, agriculture waste, beverage industry waste such as pressed grapes, food waste, vegetable inedible scraps, marine algae, freshwater algae, paper processing waste and parts of plants such as lignin, and wood waste such as saw dust.

To produce biofuel, the method further includes upgrading the biocrude intermediate to obtain biofuel or bio-oil. An embodiment of upgrading is the process of hydrodeoxygenating the biocrude intermediate at a high temperature in the presence of hydrogen, thereby removing oxygen.

In various embodiments, grinding the waste feed further comprises at least one of: ball-milling, pin milling, hammer milling, jet milling, two-roll milling, colloid milling, wet disk milling, and vibratory milling. In various embodiments, it was found that the biocrude intermediate obtained from the method using grinding is greater than 20 wt % of the waste feed, greater than 25 wt % of the waste feed, or greater than 30 wt % of the waste feed.

The biocrude obtained by this method exceeds that of older methods including using co-solvent enhanced lignin fractionation (CELF) and other methods for fractionating plant materials and obtaining lignin such as organosolv lignin and enzyme lignin. These prior processes were developed to solubilize lignin to remove it from cellulose, so that sugars could be obtained from cellulose, or paper made from the cellulose fraction. The lignin and cellulose fractions if not used to make other commercial products are also suitable plant materials for the methods herein to obtain biocrude.

In various embodiments, subjecting the pulverized waste feed to hydrothermal liquefaction includes treating the pulverized waste feed at a temperature of about 250° C. about 400° C. The temperature can be from about 250° C. to about 275° C., or from about 275° C. to about 300° C., or from about 300° C. to about 350° C. up to about 400° C. In presence of a catalyst, a lower temperature is effective to cause hydrothermal liquefaction, for example, 150° C. to 175° C., or 180° C. up to 225° C. The high temperature treatment is in various embodiments is of a duration of at least from about 25-55 minutes, 30-60 minutes to about 35-65 minutes. This temperature is hotter than previous treatments of green waste, for example, used to obtain sugar monomers from cellulose, a process that has also used enzymes. The methods herein do not rely on enzymes, and enzymes are not needed and are not used.

In various embodiments, the step of grinding yields particles of pulverized waste feed having a size of less than about 0.2 mm, less than 0.15 mm, less than 0.10 mm, less than 0.05 mm (50 micrometers), less than 0.025 mm (25 micrometers), or less than about 0.01 mm (10 micrometers). Surprisingly, these smallest of the observed sizes are about those of plant cells. The grinding yields particles of pulverized waste feed having a reduced crystallinity, as determined by analyzing by powder X-ray diffraction.

An aspect of the inventions herein provides a method for enhancing yield of a biocrude intermediate from plant waste by hydrothermal liquefaction, the method comprising:

obtaining a waste feed comprising high cellulose content;

grinding the waste feed to obtain a pulverized waste feed having reduced particle size thereby reducing the particle size; and,

subjecting the pulverized waste feed to hydrothermal liquefaction at a temperature of at least 250 C for at least 30 minutes, thereby obtaining enhanced yield of the biocrude intermediate. The inventors observed an effect of the grinding, a decreased yield of char product and, with an increased yield of the biocrude, an obtained biocrude/char ratio more than two-fold greater than from a comparison control using waste feed not subjected to grinding and otherwise identically processed. In an embodiment of this method, the grinding is ball grinding.

In various embodiments prior to grinding, the method includes adjusting the waste feed to a ratio of about 15 wt % solid:95 wt % moisture, 10 wt % solid:90 wt % moisture or about 15 wt % solid:85 wt % moisture. In various embodiments the method includes, prior to ball grinding, sieving the waste feed and eliminating large particles, for examples twigs and small branches. In an alternative embodiment the method includes not sieving the waste feed prior to the grinding step.

In various embodiments the method further includes upgrading the biocrude intermediate to obtain biofuel. Upgrading in one embodiment includes hydrodeoxygenating the biocrude intermediate at high temperature with hydrogen for the purpose of removing oxygen.

An aspect of the invention provides a composition having a high cellulose content of plant waste material pulverized by ball grinding to a particle size suitable for hydrothermal liquefaction for biocrude intermediate. Suitable materials in various embodiments include green waste, lignin waste and any of the plant-based waste products described herein. The average particle size diameter is about equal to or less than 100 micrometers (μm), which corresponds roughly to the size of a typical plant cell. This particle size corresponds to a decrease in crystallinity of the plant waste.

### BRIEF DESCRIPTION OF THE DRAWINGS

FIG. 1 is a set of photographs of green waste (left)and ball-milled green waste (second from left). The green waste is grassy and highly cellulosic, and about 70% of the green waste is cellulose and carbohydrate. These photos show the extremely small particles resulting from the ball-milling, reduces the green waste to a powder. Also shown are photographs of green waste treated by an older process, co-solvent enhanced lignin fractionation (CELF). The carbohydrate fraction from CELF is mostly cellulose soluble in the liquid from CELF fractionation, and lignin is precipitated.

FIG. 2 is a set of bar graphs showing the percent by weight of oil yield from each of the fractions shown in FIG. 1. Green waste (2 g) was heated with being ball-milled as a comparison, and another sample was ball-milled 45 min at 60 C. Oil yields from untreated starting material, green waste, was 18.1 wt % (1.7 standard deviation), and after ball-milling 35.4% (4.1). These data show that ball-milling increases oil yield by a factor of almost two-fold (96%). Two CELF fractions were each ball-milled and heated, and yielded 29.9 wt % from lignin (1.6), and 22.1 wt % (2.5) from CELF carbs.

FIG. 3 shows FT-IR spectra analyses performed on samples of the oil from sources of green waste treated as described in FIG. 2, displayed together on the same graph. From the top line, these are oils from green waste, from ball-milled green waste, from ball-milled CELF carbohydrate, and from ball-milled CELF lignin. The oil from ball-milled green waste and from each of the CELF ball-milled fractions show the same functionality as the oil from raw green waste, indicating that these oils contain the same or highly similar chemical compositions.

FIG. 4 is a set of bar graphs showing number of particles found at each of sizes from 0.05 mm (millimeters, or 50 micrometers or 50 microns) to 0.4 mm, in each of the preparations shown in FIG. 1 and for ball-milled CELF carbs. For each of the four preparations the height of the bar on the ordinate shows the count of particles at the sizes on the abscissa. The data show that the smallest particles were obtained from the method of ball-milling of green waste. Average particle sizes were observed to be: for green waste 0.16 mm (160 μm or microns, std dev 0.09), for ball-milled green waste 0.05 mm or 50 μm (0.04), for CELF carbs 0.10 mm (0.05), and for ball-milled carbs 0.06 (0.03 std dev). Ball-milling reduced average particle size more than three fold from untreated green waste.

FIG. 5 is a set of bar graphs showing the same data as in FIG. 4 for green waste, ball-milled green waste, and CELF carbs, and in addition showing data for CELF lignin. The average particle size determined for CELF lignin was 0.08 mm or 80 μm (std. dev. 0.06).

FIG. 6 is a set of graphs analyzing the relationship of particle size and oil yield. The left graph shows the oil yield as a function of average particle size in millimeters (mm) as determined in FIG. 5. The points on the graph conform to the equation y=−1.5631x+0.415, and assumes that particles are spheres. However green waste particles appear rod-like. The right graph shows oil improvement per square area as a function of average particle size (mm). Oil improvement was calculated as oil yield (%)/4rπ² in which r=d/2. The reduced particle size increases the surface area to volume ratio, thereby reducing mass transfer limitations and improving efficiency of oil extraction, thereby increasing oil yields.

FIG. 7 is a set of X-ray spectroscopy data that show increased crystallinity of ball-milled green waste and ball-milled CELF carb. The left panel shows four spectra displayed together, from the top: CELF lignin, CELF carbohydrates, ball-milled green waste, and green waste at the bottom. A shift of the 2theta intensity to the left in ball-milled green waste compared to green waste was observed, indicating an decrease in crystallinity in the ball-milled green waste compared to the green waste feed starting material. The right panel compares ball-milled CELF carbs (top tracing) to CEF carbs (bottom tracing). The data show that crystallinity correlates negatively to oil yield.

FIG. 8 is a set of four FT-IR analyses of four fractions displayed together comparing ball-milling to CELF. From the top, the tracings are of CELF lignin, CELF carbs, green waste, and ball-milled green waste. Minor differences in spectra are observed at 1000 cm⁻¹. The data generally show that the ball-milling process does not substantially affect components chemical composition of the resulting obtained oil fractions compared to greater changes in chemical composition due to the CELF process.

### DETAILED DESCRIPTION

The methods described herein are based on reactivity and accessibility of the cellulose component which is a primary constituent of biomass. Cellulose in crystalline form is less reactive than in amorphized form. Cellulose in large particles is not accessible for reaction. Mechanical grinding reduces the particle size of the cellulose and makes the cellulose accessible. Further, by mechanical grinding the cellulose is amorphized thereby making the cellulose more reactive than its native crystalline form. The mechanical grinding results in increasing the yield of the biocrude intermediate from about 20 wt % to 40 wt %. The biocrude intermediate was measured at conditions at or near optimal for example 300° C. and 60 min reaction time. In contrast to other methods using green waste, the methods described herein do not require a catalyst that deactivates with time. Even though the methods described herein do not require a catalyst, the methods are compatible with catalysts to improve the yield of biocrude intermediate. The economic projections indicate that a 20 wt % yield corresponds to a fuel selling price of about $5.00/gallon and a 40 wt % yield corresponds to a selling price of about $3.00/gallon.

Large scale lawn areas such as golf courses and cemeteries, not to mention surburban housing tracts, generate enormous quantities of grass clippings. Corn monoculture across much of the U.S. generates corn stover including leaves and stalks. Sugar cane processing in growing regions such as Texas and Louisiana generates extensive plant waste of stalks after pressing. The bulk tissue from banana plants, one of the largest fruit crops in the world, arises fresh from perennial roots each year and the producing plant is merely an annual, the mature plant following fruit harvest constitutes a very large biomass. Cotton is an annual and the product is obtained only from the mature flowers, leaving the bulk of the plant each year as leaves and stalks. Legumes such as soy crops, and tobacco, generate large amounts of unused plant material following harvest of fruit or tender leaves, respectively. These and many other plant materials are suitable large scale waste feeds for use in the methods herein.

An aspect of the invention described herein provides a method for obtaining a biocrude intermediate by hydrothermal liquefaction, the method including: obtaining a waste feed comprising high cellulose content; grinding the waste feed to obtain a pulverized waste feed; subjecting the pulverized waste feed to hydrothermal liquefaction thereby obtaining the biocrude intermediate.

In an embodiment of the method the waste feed further includes at least one of: green waste, yard waste, and wood waste. An embodiment of the method further includes upgrading the biocrude intermediate to obtain biofuel or bio-oil.

In an embodiment of the method, grinding the waste feed further includes at least one of:

ball-milling, pin milling, hammer milling, jet milling, two-roll milling, colloid milling, wet disk milling, and vibratory milling. In an embodiment of the method, the biocrude intermediate is greater than 20 wt % of the waste feed.

Hydrothermal liquefaction is a very promising method for converting abundant organic wet waste into fuels. The biggest bottleneck is producing a biocrude intermediate that can be upgraded to a finished fuel. Some wastes, such as yard waste or green waste, are abundant and inexpensive, but do not provide sufficient biocrude yield to be economically viable. Of course, this calculation changes as the carbon dioxide burden and methane production burden of dispensing of these wastes increases with time.

Sitotaw et al. (2021, Biomass Conversion and Biorefinery, 22:1-24 (2021) review a variety of pretreatments including use of enzymes and.or fermentations by microorganisms, and milling for use in obtaining sugars from plant biomass. This reference provides a variety of milling methods and apparatuses.

The methods provided herein involve mechanical activation of the biomass-based feed, thus increasing the biocrude yield from roughly 20 wt % to 40 wt %. Calculations of economic projections show that this is the difference between non-competitive and competitive with respect to current fossil fuel prices. The U.S. alone produces roughly 50 million tons of these types of wastes per year and there is no current good solution for their use.

The methods provided herein involve mechanical steps based on improving the reactivity and accessibility of the cellulose-associated lipid cell membrane and cytoplasmic lipid components that are the main targets for obtaining oil from the biomass. When feed is in large particles, these lipid components are not accessible for chemical reaction. Mechanical grinding reduces the particle size, making the cellulose accessible, and amorphizing it, making it more reactive than in native crystalline form. The result using optimal conditions (300 C and 60 min reaction time) is to increase the yield of the biocrude intermediate form from about 20 wt % to about 40 wt %. Relative to competing approaches, these methods do not require any catalysts that are expensive and will deactivate with time, nor are expensive heat labile enzymes required. It is hypothesized that the methods herein are compatible with use of catalysts, further enhancing the yields.

The mechanical grinding treatment is simple, low energy and effective. Obtaining an increase in biocrude yield from 20 wt % to 40 wt % makes otherwise unattractive feeds economically viable, including leaf, fruit and vegetable waste from a variety of industries and leisure and domestic land uses. Currently, in New England for example seasonal disposal of Christmas trees and decorative wreaths is solved by feeding to goats, however there may be insufficient goat usage to solve disposal problems, while other locations may lack this means of recycling. Crops such as apples produce waste in the form of fallen bruised fruit. Zoos that feed large herbivorous animals (elephants, zebras, hippos, rhinos, apes) often have a substantial supply of vegetable waste. Golf courses, cemeteries, highway borders are sources of green waste. Economic projections indicate that a 20 wt % yield corresponds to a fuel selling price at breakeven of about $5/gallon, and 40 wt % yield corresponds to a break even of about $3/gallon, rendering the methods herein competitive.

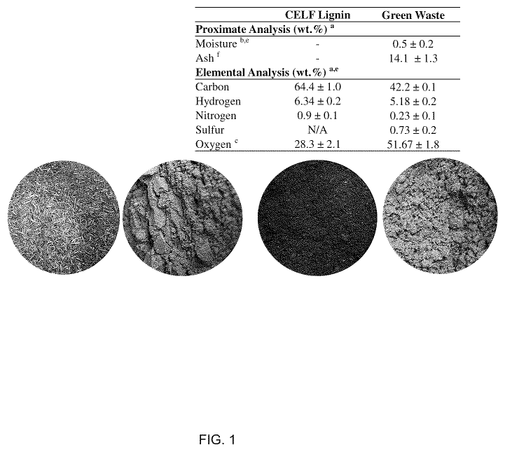

With reference now to the drawings, FIG. 1 shows the extremely small particles resulting from the ball-milling, that this method reduces the green waste to a powder. Also shown are photographs of green waste treated by an older and different process, co-solvent enhanced lignin fractionation (CELF). Solvent generally used for CELF is tetrahydrofuran.

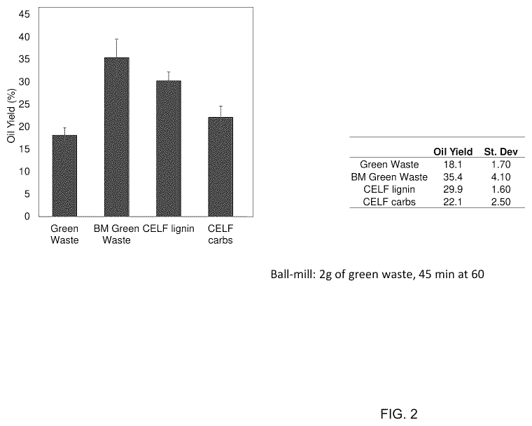

FIG. 2 shows that oil yields from starting feed, green waste, was 18.1 wt %, and after ball-milling 35.4% therefore ball-milling increased oil yield by 96%, almost a doubling of recovery.

Since a recovery of 100% is not plausible, the observed doubling in yield is highly significant. Further ball-milling fractions obtained from CELF yielded only 29.9 wt %, and from CELF carbs without ball-milling, 22.1 wt %. These data show the generality of increasing yields from plant materials by a process of grinding to pulverize the materials in addition to using heat to obtain biocrude.

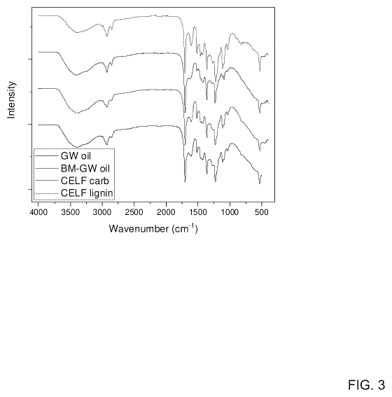

FIG. 3 uses Fourier-transform infra-red (FT-IR) spectra analyses that the oil from ball-milled green waste shows the same functionality as the oil from raw green waste, indicating that these oils contain the same or highly similar chemical compositions.

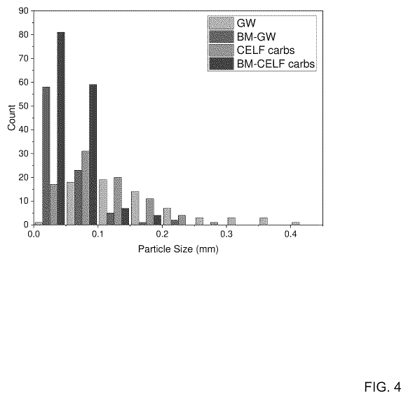

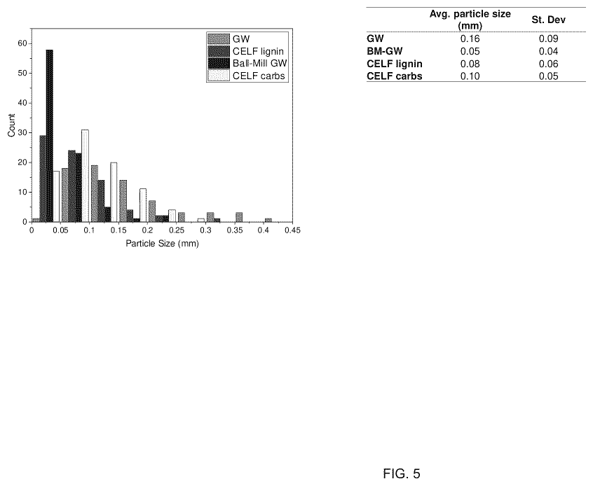

The data in FIG. 4 show that the smallest particles result from ball-milling of green waste and ball-milling of CELF carbohydrates, and the largest particles are found in the untreated green waste and in CELF carbs. Average particle sizes were observed to be: for green waste 0.16 mm, for ball-milled green waste 0.05 mm, for CELF carbs 0.10 mm, and for ball-milled carbs 0.06. The particle sizes from ball-milling, 50 micrometers and 60 micrometers, correspond in order of magnitude, to average sizes for plant cells, indicating that the ball-milling process has reduced the plant waste material to the units of cellulose production. The data from FIGS. 4 and 5 show that ball-milling reduces green waste particle size by 70% compared to the CELF process alone, which reduces particle size by 44%.

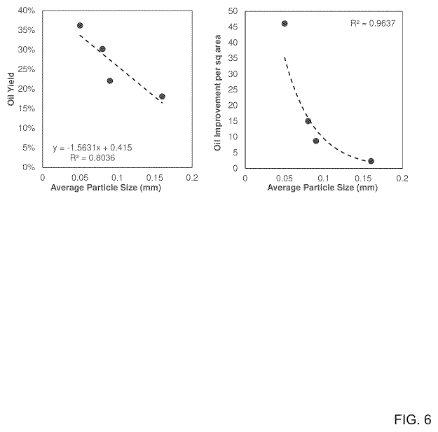

Most important, FIG. 6 examines the relationship of particle size and oil yield. The left graph shows the oil yield as a function of average particle size in millimeters (mm) as determined in FIG. 5. The points on the graph conform to the equation y=−1.5631x±+0.415, and assumes that particles are spheres. However that particles from untreated green waste feed appear rod-like. The right graph shows oil improvement per sq area as a function of average particle size (mm). Oil improvement was calculated as oil yield (%)/4rπ² in which r=d/2. The reduced particle size increases the surface area to volume ratio, thereby reducing mass transfer limitations and improving efficiency of oil extraction by the steps of the methods herein, thereby increasing oil yields.

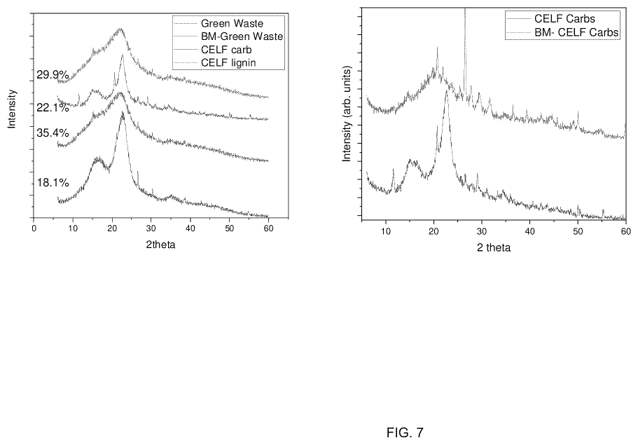

FIG. 7 is a set of X-ray spectroscopy data that show decreased crystallinity of ball-milled green waste and ball-milled CELF carb. See, Park, S., et al., Biotechnology for Biofuels, 3: 10 (2010) for methods involving crystallography of celluloses. A shift of the 2theta intensity to the left in ball-milled green waste was observed compared to green waste that had not been ball-milled, indicating an decrease in crystallinity in the ball-milled green waste compared to the green waste feed starting material. These data show that for the plant materials analyzed, decreases in observed crystallinity correlates to increases in oil yield. It is likely that the lipids of the cell membranes which are internal to various cellulose layers of plant cells, including the polyphenolic lignin compounds which are external, are more accessible to liberation by heat treatment subsequent to ball-milling, increasing recovery after this pre-treatment process, resulting in improved yield of biocrude.

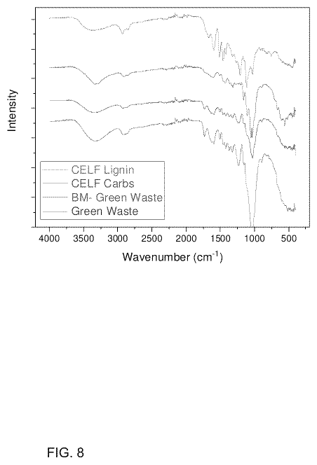

The FT-IR analyses in FIG. 8 comparing ball-milling of raw plant materials and to CELF fractions are data generally showing that the ball-milling process does not substantially affect chemical compositions of the resulting obtained oil fractions.

It is understood that any feature described in relation to any one of the embodiments provided herein may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The invention now having been fully described is further exemplified by the following claims. Those skilled in the art will recognize or be able to ascertain using no more than routine experimentation, numerous equivalents to the specific methods described herein. Such equivalents are within the scope of the present invention and claims. The contents of all references including issued patents and published patent applications cited in this application are hereby incorporated herein by reference in their entireties.

What is claimed is:

1. A method for obtaining a biocrude intermediate by hydrothermal liquefaction, the method comprising:
obtaining a waste feed comprising high cellulose content;
grinding the waste feed to obtain a pulverized waste feed; and,
subjecting the pulverized waste feed to hydrothermal liquefaction at a temperature selected from greater than about 250° C. in absence of a catalyst, or greater than about 150° C. in presence of a catalyst, thereby obtaining the biocrude intermediate.

2. The method according to claim 1, the waste feed further comprises at least one of: green waste, yard waste, zoo waste feed, zoo herbivore animal fecal matter, florist industry waste, agriculture waste, beverage industry waste such as pressed grapes, food waste, vegetable inedible scraps, marine algae, freshwater algae, lignin from paper making or sugar manufacture, and wood waste such as saw dust.

3. The method according to claim 1 further comprising upgrading the biocrude intermediate to obtain biofuel or bio-oil.

4. The method according to claim 3, upgrading comprises hydrodeoxygenating the biocrude intermediate at high temperature with hydrogen thereby removing oxygen.

5. The method according to claim 1, grinding the waste feed further comprises at least one of: ball-milling, pin milling, hammer milling, jet milling, two-roll milling, colloid milling, wet disk milling, and vibratory milling.

6. The method according to claim 1, wherein the biocrude intermediate obtained is greater than 20 wt % of the waste feed, greater than 25 wt % of the waste feed, or greater than 30 wt % of the waste feed.

7. The method according to claim 1 wherein subjecting to hydrothermal liquefaction further comprises treating the pulverized waste feed at a temperature of about 250° C. to about 400° C.

8. The method according to claim 7, wherein subjecting is at least from about 25-55 minutes, 30-60 minutes to about 35-65 minutes.

9. The method according to claim 1 wherein grinding obtains particles of pulverized waste feed having a size of less than about 0.2 mm, less than 0.15 mm, less than 0.10 mm, less than 0.05 mm (50 μm), less than 0.025 mm (25 μm), or less than about 0.01 mm (10 μm).

10. The method according to claim 1, wherein grinding obtains particles of pulverized waste feed having a reduced crystallinity analyzing by powder X-ray diffraction.

11. The method according to claim 1, the steps performed in absence of exogenously added enzyme and/or in absence of catalysts.

12. A method for enhancing yield of a biocrude intermediate from plant waste by hydrothermal liquefaction, the method comprising:
obtaining a waste feed comprising high cellulose content;
grinding the waste feed to obtain a pulverized waste feed with particle size reduction; and,
subjecting the pulverized waste feed to hydrothermal liquefaction at a temperature of at least about 250° C. for at least about 30 minutes, thereby obtaining enhanced yield of the biocrude intermediate.

13. The method according to claim 12, observing decreased yield of char product and an obtained biocrude/char ratio more than two-fold greater than from waste feed not subjected to the step of grinding for size reduction and otherwise identical.

14. The method according to claim 12, further comprising prior to ball grinding, adjusting the waste feed to a ratio of about 15 wt % solid: 95 wt % moisture, 10 wt % solid: 90 wt % moisture or about 15 wt % solid: 85 wt % moisture.

15. The method according to claim 12, further comprising prior to grinding, sieving the waste feed thereby eliminating large particles.

16. The method according to claim 12, the grinding is ball grinding.

17. The method according to claim 12, further upgrading the biocrude intermediate to obtain biofuel.

18. The method according to claim 17, upgrading comprises hydrodeoxygenating the biocrude intermediate at high temperature with hydrogen thereby removing oxygen.

19. A composition comprising a high cellulose content plant waste material or a lignin waste product pulverized by ball grinding to a particle size suitable for hydrothermal liquefaction for biocrude intermediate.

20. The composition according to claim 19, the particle size has an average diameter of less than 100 micrometers (100 μm).
